(19) United States
(12) Patent Application Publication
(10) Pub. No.: US 2026/0258246 A1
(43) Pub. Date: Sep. 3, 2026

(54) ADDITIVES FOR POLYURETHANE FOAM POLYOL BLENDS AND POLYURETHANE FOAMS COMPRISING THE SAME

(71) Applicant: Momentive Performance Materials Inc., Niskayuna, NY (US)

(72) Inventors: Jason Stengel, Marietta, OH (US); Pierre Chaffanjon, Leverkusen (DE); David Davis, St. Marys, WV (US)

(21) Appl. No.: 18/876,001

(22) PCT Filed: Jul. 5, 2023
(86) PCT No.: PCT/US2023/026882

§ 371 Date: Dec. 17, 2024

Related U.S. Application Data
(60) Provisional application No. 63/358,640, filed on Jul. 6, 2022.

(51) Int. Cl. C08L 75/04; C08J 9/00

(52) U.S. Cl. CPC C08L 75/04; C08J 9/0061; C08J 2201/022; C08J 2375/04; C08J 2483/12; C08L 2203/14; C08L 2205/025; C08L 2205/03; C08L 2205/08

(57) ABSTRACT

The present technology provides a method of manufacturing a rigid polyurethane foam having a low thermal conductivity from a foam composition comprising a polyol, an isocyanate, a polyurethane catalyst, a surfactant, and a compatibility additive. The compatibility additive enhances the compatibility of one or more components in the foam forming composition with the polyol component.

### CROSS-REFERENCE TO RELATED APPLICATIONS

This application claims priority to and the benefit of U.S. Provisional Patent Application No. 63/358,640 filed Jul. 6, 2022, the disclosure of which is incorporated herein by reference in its entirety.

### FIELD

The present technology relates generally to polyurethane foam compositions and foams made from such compositions. More particularly, the present technology relates to additives for enhanching the compatibility of components in polyurethane foam compositions and particularly for enhancing the compatibility of components with a polyol. The technology also relates to polyurethane foams formed using such compositions and additives.

### BACKGROUND

Rigid polyurethane and polyisocyanurate foams are widely used as insulating materials in the construction industry. These foams display excellent insulation characteristics.

Conventional rigid polyurethane foam, such as may be used in insulating applications, is generally prepared by the reaction of at least one polyol with at least one isocyanate in the presence of suitable catalysts, surfactants, water, and blowing agents. In mixtures with polyols, whether as a separate polyol component in a two-part composition or in a one-part compositions comprising each of the components, the respective components may separate over time and/or may not be sufficiently compatable such that the composition is hazy (i.e., lacks clarity).

### SUMMARY

The present technology provides an additive for polyols employed in polyurethane foam compositions. The additive functions as a compatibilizer in a polyol suitable for use in polyurethane foam compositions such as, for example, rigid polyurethane foams. The additives provide stability to the polyol. In one embodiment, the additive is provided to a polyol pre-blend to provide stability and clarity to the polyol pre-blend. This may be seen in appearance of the polyol in that separation of the components in the pre-blend is reduced or avoided and/or in the clarity in the polyol pre-blend.

The additives may also serve to aid in retention of the blowing agents during production of a polyurethane foam.

Additionally, the use of the additives have minimal to no negative impact on the physical properties of foams produced using the present additives.

In one aspect, the present technology provides a polyurethane foam composition comprising a polyol, an isocyanate, a polyurethane catalyst, a surfactant, a compatibility additive in accordance with the present technology, water, optionally a physical blowing agent, optionally a chemical blowing agent, optionally a fire retardant additive or a mixture thereof, and optionally other processing additives. The compatibility additive is a silicone based compound comprising a pendant polyether group and has been found to reduce or prevent separation of components in a polyol composition, e.g., a polyol pre-blend for a polyurethane foam or a one-part polyurethane foam composition.

In one aspect, provided is a polyurethane or polyisocyanurate foam composition comprising: a polyol or a mixture thereof; an isocyanate; a compatibility additive; a surfactant; and a polyurethane catalyst or a mixture thereof;
wherein the compatibility additive is selected from a compound of the formula:

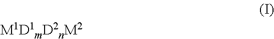

where:
M¹ is (R¹)(R²)(R³)Si—O_{1/2}
M² is (R⁴)(R⁵)(R⁶)Si—O_{1/2}
D¹ is (R⁷)(R⁸)Si—O_{2/2}
D² is (R⁹)(R¹⁰)Si—O_{2/2}
R¹⁰ is —CH₂—CH(R¹⁰)—CH₂—O—[CH₂CH(CH₃)O]ₚ—[CH₂CH₂O]_{q}—R¹²
R¹, R², R³, R⁴, R⁵, and R⁶, are independently selected from a C1-C10 alkyl or R¹⁰;
R⁷, R⁸, and R⁹ are independently selected from a C1-C10 alkyl,
R¹⁰ is H or a C1-C10 alkyl;
R¹² is H, a C1-C10 alkyl, or an acetyl group;
m is 0 to 100;
n is 1 to 50;
p is 0 to 35;
q is 0-45; and
p+q≥1.

In one embodiment, the composition is a two-part composition comprising (i) a first part comprising the isocyanate, and (ii) a second part comprising the polyol and the compatibility additive.

In one embodiment, m is 0 and n is 1.

In one embodiment, p is 1 to 10. In one embodiment, q is 0.

In one embodiment, q is 1 to 10. In one embodiment, p is 0.

In one embodiment, m≥0, and n is ≥1, wherein m:n is ≤6:1.

In one embodiment, the ratio of m:n is from about 0.1:1 to 6:1

In one embodiment, 0<m≤15 and 1<n≤5.

In one embodiment, in accordance with any of the previous embodiments, R¹¹ is H.

In one embodiment, in accordance with any of the previous embodiments, R¹¹ is a C1-C10 alkyl. In one embodiment, R¹¹ is methyl.

In one embodiment, in accordance with any of the previous embodiments, the compound of Formula (I) has a silicon content of less than 25 wt. % of the weight of Formula (I).

In one embodiment, in accordance with any of the previous embodiments, the compound of Formula (I) has a silicon content of less than 20 wt. % of the weight of Formula (I).

In one embodiment, in accordance with any of the previous embodiments, the compound of Formula (I) has a silicon content of from about 1 wt. % to about 25 wt. % of the weight of Formula (I).

In one embodiment, in accordance with any of the previous embodiments, the compatibility additive is present in an amount of from about 0.5 to about 20 parts per one hundred parts polyol.

In one embodiment, in accordance with any of the previous embodiments, the compatibility additive is present in an amount equivalent to the amount of surfactant present in the composition.

In one embodiment, in accordance with any of the previous embodiments, the compatibility additive is present in an amount of greater than the amount of surfactant present in the composition.

In one embodiment, in accordance with any of the previous embodiments, the compatibility additive is present in an amount of from about 1.2 times to 6 times the amount of surfactant present in the composition.

In one embodiment, in accordance with any of the previous embodiments, the composition further comprises a blowing agent.

In yet another aspect, provided is a method of forming a foam comprising reacting the composition in accordance with any of the previous embodiments.

### DETAILED DESCRIPTION

The present technology provides a an additive for enhancing the compatibility of components in a foam forming composition, a foam forming composition comprising such additives, and foams made from such foam forming compositions. The compositions may be used to provide rigid foams. The foam compositions comprise: (a) a polyol component; (b) an isocyanate component; (c) a compatibility additive; (d) a surfactant; and (e) a catalyst component. The polyol component and the isocyanate component can be provided as separate components as part of a two-part composition or as a one-part mixture. The compatibility additive has been found, for example, to enhance the compatibility of components employed in foam forming compositions with polyols.

The compatibility additive is a silicone based compound comprising a pendant polyether group. In one embodiment, the compatibility additive is selected from a compound of the formula (I):

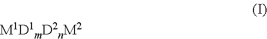

where:
M¹ is (R¹)(R²)(R³)Si—O_{1/2}
M² is (R⁴)(R⁵)(R⁶)Si—O_{1/2}
D¹ is (R⁷)(R⁸)Si—O_{2/2}
D² is (R⁹)(R¹⁰)Si—O_{2/2}
R¹⁰ is —CH₂—CH(R¹⁰)—CH₂—O—[CH₂CH(CH₃)O]ₚ—[CH₂CH₂O]_{q}—R¹²
R¹, R², R³, R⁴, R⁵, and R⁶, are independently selected from a C1-C10 alkyl or R¹⁰;
R⁷, R⁸, and R⁹ are independently selected from a C1-C10 alkyl,
R¹⁰ is H or a C1-C10 alkyl;
R¹² is H, a C1-C10 alkyl, or an acetyl group;
mis 0 to 100;
n is 1 to 50;
p is 0 to 35;
q is 0-45; and
p+q≥1.

In one embodiment, R¹, R², R³, R⁴, R⁵, R⁶, R⁷, R⁸, and R⁹ are independently selected from a C1-C10 alkyl, a C2-C8 alkyl, or a C4-C6 alkyl. In one embodiment, R¹, R², R³, R⁴, R⁵, R⁶, R⁷, R⁸, and R⁹ are independently selected from a C1-C4 alkyl or a C1-C2 alkyl. In one embodiment, R¹, R², R³, R⁴, R⁵, R⁶, R⁷, R⁸, and R⁹ are independently selected from methyl, ethyl, propyl, isopropyl, butyl, isobutyl, tert-butyl, pentyl, isopentyl, hexyl, heptyl, octyl, nonyl, or decyl. In one embodiment, each of R¹, R², R³, R⁴, R⁵, R⁶, R⁷, R⁸, and R⁹ is methyl.

In one embodiment, R¹, R², R³, R⁴, R⁵, and R⁶ are independently selected from a C1-C10 alkyl or R¹⁰, wherein at least one of R¹, R², R³, R⁴, R⁵, and/or R⁶ is a R¹⁰ group. In one embodiment, at least one of R¹, R², or R³ is a R¹⁰ group, and at least one R⁴, R⁵, or R⁶ is a R¹⁰ group.

R¹⁰ is selected from H or a C1-C10 alkyl. In one embodiment, R¹⁰ is H. In one embodiment, R¹⁰ is selected from a C1-C10 alkyl, a C2-C8 alkyl, or a C4-C6 alkyl. In one embodiment, R¹⁰ is —CH3.

The R¹⁰ group comprise polyethylene and polypropylene units and contain polyethylene glycol and/or polypropylene glycol units formed with the R¹² group, which is hydrogen. In the R¹⁰ group, p is 0 to 35, 1 to 30, 5 to 25, or 10 to 20; and q is 0 to 45, 1 to 40, 5 to 35, 10 to 30, or 15 to 25, where p+q≥1. In one embodiment, q is 0 and p is ≥1. In one embodiment, q is 0, and p is 1 to 10, 2 to 8, or 3 to 5. In one embodiment, p is 0 and q is ≥1. In one embodiment, p is 0 and q is 1 to 10, 2 to 8, or 3 to 5.

The R¹⁰ group can have a number average molecular weight of from about 85 to about 4000, from about 200 to about 2000, or from about 400 to about 1500. The molecular weight of the R¹⁰ unit can be determined by end group analysis, specifically hydroxyl and unsaturation values obtained by titration and further corroborated through NMR analyses.

The compatibility additive comprises at least on D² group, i.e., n is at least 1. In one embodiment, the compatibility additive is a trisiloxane where m is 0 and n is 1. In embodiments, the compatibility additive comprises a D¹ and a D² group, where n is 1 to 50, 2 to 40, 5 to 35, 10 to 30, or 15 to 25; and m is 1 to 100, 5 to 90, 10 to 80, 15 to 75, 20 to 65, 25 to 60, 30 to 50, or 40 to 45. In embodiments in which m is greater than 1, the ratio of m:n is ≤6:1, ≤5:1, ≤4:1, ≤3:1. In one embodiment in which m is greater than 1, the ratio of m:n is from about 0.1:1 to 6:1, from about 0.5:1 to about 5:1, from about 1:1 to about 4:1, or from about 2:1 to about 3:1.

In one embodiment, in the compound of Formula (I), 0<m<15 and 1<n≤5; 1≤m≤12 and 2≤n≤4; or 5≤m≤10 and 3≤n≤4.

Two or more compatibility additives can be employed in a foam forming composition, and particularly with a polyol component of a foam forming composition. In one embodiment, the composition comprises at least one compatibility additive of the formula (I) wherein m is 0 and n is 1. In one embodiment, the polyol composition comprises a first compatibility additive of the formula (I) where m is 0 and n is 1, and a second compatibility additive of the formula (I) where m is 0 and n is 1, wherein the first compatibility additive and the second compatibility additive differ from one another with respect to any of the R¹-R⁹ groups, their R¹⁰ groups, and/or the ratio of p:q in the R¹⁰ group.

In one embodiment, the composition comprises a first compatibility additive of the formula (I), wherein m is 0 and n is 1, and a second compatibility additive, wherein m is ≥1 and n is ≥1 and the ratio of m:n is ≤9:1, ≤7.5:1, ≤6:1, ≤5:1, or ≤4:1. In one embodiment, the ratio of m:n is from about 1:1 to about 9:1, from about 2:1 to about 8:1, from about 3:1 to about 7:1, or from about 4:1 to about 6:1.

The compatibility additive of Formula (I), in embodiments, has a silicon content of less than 25 wt. %, less than 20 wt. %, less than 17.5 wt. %, less than 15 wt. %, or less than 10 wt. % of the additive of Formula (I). In one embodiment, the compatibility additive of Formula (I) has a silicon content of from about 1 wt. % to about 25 wt. %, from about 3 wt. % to about 20 wt. %, from about 5 wt. % to about 17.5 wt. % or from about 10 wt. % to about 15 wt. % based on the weight of the additive of Formula (I).

The compatibility additive can be present in an amount of from about 0.5 parts to about 20 part per hundred parts polyol (pphp), from about 1 pphp to about 15 pphp, from about 2.5 pphp to about 10 pphp, or from about 5 pphp to about 7.5 pphp based on the weight of the polyol composition. In one embodiment, the polyol additive is present in an amount of from about 1.5 pphp to about 7 pphp, from about 2 pphp to about 6 pphp, or from about 2.5 pphp to about 5 pphp. based on the total weight of the polyol composition.

In one embodiment comprising a first compatibility additive where m is 0 and n is 1, and a second compatibility additive where m is ≥1 and n is ≥1, the first compatibility additive is present in an amount of from about 1 pphp to about 15 pphp, about 1.5 pphp to about 12 pphp, about 3 pphp to about 10 pphp, or about 4 pphp to about pphp, and the second compatibility additive is present in an amount of from about 0.5 wt. % to about 6 wt. %, about 1 pphp to about 5 pphp, or about 2 pphp to about 4 pphp.

In one embodiment, the compatibility additive is present in an amount of from about 1.2 to about 6 times the amount of surfactant, from about 1.5 to about 5.5 times the amount of surfactant, from about 2 to about 5 times the amount of surfactant, or from about 2.5 to about 4 times the amount of surfactant.

The polyol component is not particularly limited and may be chosen as desired for a particular purpose or intended application. In various embodiments, the polyol may be chosen from polyester polyols, polyether polyols, polycarbonate polyols, hydroxyl-terminated polyolefin polyols etc., or a combination of two or more thereof. The polyols may be, for example, polyester diols, polyester triols, polyether diols, polyether triols, etc. Alternatively, the polyol may be selected from the group of polythioether polyols, polycaprolactones, brominated polyether polyols, acrylic polyols, etc., or a combination of two or more thereof. When high functionality polyether polyols are used, the high functionality polyether polyol may have a functionality from about 3 to about 6. Polyols such as sucrose or sorbitol initiators may be mixed with lower functionality glycols or amines to bring the functionality of the polyols in the about 3.5 to about 5 range.

Suitable polyols include, but are not limited to, those having 2 to 8 hydroxyl groups per molecule and a number average molecular weight of from 200 to 10,000, preferably from 500 to 7,500. Examples of suitable polyols include, but are not limited to, polyether diols and triols and polyols, polyester diols and triols and polyols, and hydroxyl-terminated polyolefin polyols such as the polybutadiene diols. Other examples of suitale polyols include sucrose and amine-started (initiated) polyols, polymer polyols (also graft polymer polyols, graft polyols or copolymer polyols, all of which are names used to describe dispersions of vinyl polymers in polyols produced by the in-situ polymerizarion of vinyl monomers (usually styrene and or acrylonitrile) in the base polyol), polyols derived from naturally occurring materials such as castor oil, chemically-modified soybean oil or other chemically-modified fatty acid oils and polyols resulting from the alkoxylation of such naturally occurring materials as castor oil and soybean oil.

Additionally, other particularly suitable polyols include aromatic polyester polyol. The aromatic polyester polyol may be prepared from substantially pure reactant materials or more complex starting materials, such as polyethylene terephthalate, may be used. Additionally, dimethyl terephthalate (DMT) process residues may be used to form aromatic polyester polyol.

The aromatic polyester polyol may comprise halogen atoms. It may be saturated or unsaturated. The aromatic polyester polyol may have an aromatic ring content (expressed as weight percent of groups containing at least one aromatic ring per molecule) that is at least about 30 percent by weight, based on the total compound weight, at 35 percent by weight, even about 40 percent by weight. Here as elsewhere in the specification and claims, numerical values may be combined to form new or undisclosed ranges. Polyester polyols having an acid component that advantageously comprises at least about 30 percent by weight of phthalic acid residues, or residues of isomers thereof, are particularly useful.

The aromatic polyester polyol may have a hydroxyl number of greater than about 50 mg KOH/g, greater than about 100 mg KOH/g, greater than about 150 mg KOH/g, greater than about 200 mg KOH/g, greater than about 250 mg KOH/g, greater than about 300 mg KOH/g, greater than about 350 mg KOH/g, and even greater than about 400 mg KOH/g. Here as elsewhere in the specification and claims, numerical values may be combined to form new and non-disclosed ranges.

In one embodiment, the aromatic polyester polyol has a functionality that is greater than about 1, greater than about 2, greater than about 3, greater than about 4, greater than about 5, greater than about 6, greater than about 7, and even greater than about 8. Here as elsewhere in the specification and claims, numerical values may be combined to form new and non-disclosed ranges.

Exemplary polyols are the polyether diols, triols, tetrols and polyols of even greater hydroxyl functionality heretofore employed in the manufacture of polyurethane foams. Polyether polyols are typically prepared by reacting a starter compound such as a polyhydroxyl compound, e.g., ethylene glycol, diethylene glycol, propylene glycol, glycerol, sucrose, etc., or polyamine such as ethylene diamine, and the like, with one or more alkylene oxides, phenyl-substituted alkylene oxides and/or cyclic ethers such as ethylene oxide, propylene oxide, styrene oxide, tetrahydrofuran, etc. The selected polyether polyol(s) advantageously have a number average molecular weight value (Mn) of from 200 to 10,000 and preferably from 250 to 8,000. Mixtures of different polyether polyols are contemplated. Examples of some useful polyether polyols include Voranol 220-028, Voranol 220-094, Voranol 225, Voranol 270, Voranol 490 and Voranol 800 (products of The Dow Chemical Company) and Arcol 1 1-34 (Bayer MaterialScience), and the like.

The foam composition also includes an isocyanate composition. The isocyanate may include at least one isocyanate and may include more than one isocyanate. The isocyanate may be selected from an aromatic isocyanate, an aliphatic isocyanate, or any combination thereof. The isocyanate composition may include an aromatic isocyanate such as polymeric MDI. If the isocyanate composition includes an aromatic isocyanate, the aromatic isocyanate may correspond to the formula R⁵(NCO)z where R⁵ is a polyvalent organic radical which is aromatic and z is an integer that corresponds to the valence of R⁵. Generally, z is at least 2.

The isocyanate composition may include, but is not limited to, 1,4-diisocyanatobenzene, 1,3-diisocyanato-o-xylene, 1,3-diisocyanato-p-xylene, 1,3-diisocyanato-m-xylene, 2,4-diisocyanato-1-chlorobenzene, 2,4-diisocyanato-1-nitro-benzene, 2,5-diisocyanato-1-nitrobenzene, m-phenylene diisocyanate, p-phenylene diisocyanate, 2,4-toluene diisocyanate, 2,6-toluene diisocyanate, mixtures of 2,4- and 2,6-toluene diisocyanate, 1,5-naphthalene diisocyanate, 1-methoxy-2,4-phenylene diisocyanate, 4,4′-diphenylmethane diisocyanate, 2,4′-diphenylmethane diisocyanate, 4,4′-biphenylene diisocyanate, 3,3′-dimethyl-4,4′-diphenylmethane diisocyanate, and 3,3′-dimethyldiphenylmethane-4,4′-diisocyanate, triisocyanates such as 4,4′,4″-triphenylmethane triisocyanate polymethylene polyphenylene polyisocyanate and 2,4,6-toluene triisocyanate, tetraisocyanates such as 4,4′-dimethyl-2,2′-5,5′-diphenylmethane tetraisocyanate, toluene diisocyanate, 2,2′-diphenylmethane diisocyanate, 2,4′-diphenylmethane diisocyanate, 4,4′-diphenylmethane diisocyanate, polymethylene polyphenylene polyisocyanate, corresponding isomeric mixtures thereof, and any combination thereof.

The foam composition also includes one or more catalysts, e.g., a gelation catalyst, a blowing catalyst, or a trimerization catalyst. Catalysts generally catalyze the reaction of the-polyol (the main polyol component and/or the modified or unmodified phenolic resin) and an isocyanate composition. Specifically, a gelation catalyst may catalyze the hydroxyl to isocyanate reaction to generate a urethane bond. A blowing catalyst may promote a water to isocyanate reaction to generate a urea bond. A trimerization catalyst may promote a reaction of three isocyanate groups to form an isocyanurate bond. The catalyst of the present technology may include one or more catalysts and typically includes a combination of catalysts. The catalyst may catalyze the exothermic reaction between the resin composition and the isocyanate composition. The catalyst is generally not consumed in the exothermic reaction. The catalyst may include any suitable catalyst or mixtures of catalysts known in the art. Examples of suitable catalysts include, but are not limited to, amine catalysts in appropriate diluents, e.g., bis(dimethylaminoethyl)ether in dipropylene glycol; and metal catalysts, e.g., tin, bismuth, lead, etc. If included, the catalyst may be included in various amounts. In one embodiment, the catalyst is selected from the group of, N,N-dimethylcyclohexylamine (DMCHA), N,N,N′,N′,N″-pentamethyldiethylenetriamine (PMDETA), amidines such as 2,3-dimethyl-3,4,5,6-tetrahydropyrimidine, tertiary amines such as triethylamine, tributylamine, dimethylbenzylamine, N-methylmorpholine, S-ethylmorpholine, N-cyclohexylmorpholine, N,N,N′,N′-tetramethylethylenediamine, N,N,N′,N′-tetramethylbutanediamine, N,N,N′,N′-tetamethylhexane-1,6-diamine, pentamethyldiethylenetriamine, bis(dimethylaminoethyl)ether, bis(dimethylaminopropyl)urea dimethylpiperazine, 1,2-dimethylimidazole, 1-azabicyclo[3.3.0]octane and typically 1,4-diazabicyclo[2.2.2]octane, alkanolamine compounds such as triethanolamine, triisopropanolamine, N-methyldiethanolamine, N-ethyldiethanolamine, dimethylethanolamine, tris(dialkylaminoalkyl)-s-hexahydrotriazines, including tris(N,N-dimethylaminopropyl)-s-hexahydrotriazine, tetraalkylammonium hydroxides including tetramethylammonium hydroxide, alkali metal hydroxides including sodium hydroxide and potassium hydroxide, alkali metal alkoxides including sodium methoxide and potassium isopropoxide, alkali metal salts of long-chain fatty acids having from 10 to 20 carbon atoms and/or lateral hydroxyl groups, tin, iron, lead, bismuth, mercury, titanium, hafnium, zirconium, iron(II) chloride, zinc chloride, lead octoate stabilized stannous octoate, tin(II) salts of organic carboxylic acids such as tin(II) acetate, tin(II) octoate, tin(II) ethylhexanoate and tin(II) laurate, and dialkyltin(IV) salts of organic carboxylic acids such as dibutyltin dilaurate, dibutyltin diacetate, dibutyltin maleate and dioctyltin diacetate, potassium salts, potassium octoate, potassium acetate, and any combinations thereof. In various embodiments, the catalyst may be included in amounts of from 0.5 to 3, of from 0.5 to 8, of from 1 to 7, of from 3 to 5.5, even 3.5 to 4.5 weight percent of the foam composition. Here as elsewhere in the specification and claims, numerical values may be combined to form new or undisclosed ranges.

Catalysts include, for example, foam-forming organometallic catalysts such as nickelacetoacetonate, ironacetoacetonate, tin-based catalysts, bismuth-based catalysts and zinc-based catalysts. Other useful urethane catalysts include alkali metal carboxylates such as potassium octoate, potassium acetate, sodium acetate and sodium octoate, heavy metal-based catalysts such as those of mercury or lead, tertiary amine urethane catalysts such as triethylene diamine and bis(dimethylaminoethyl)ether, and quaternary ammonium salt catalysts such as quaternary ammonium carboxylate, e.g., DABCO® TMR catalyst from Air Products.The foam compositions may also include a surfactant.

The surfactant may be a silicone surfactant, a non-silicone surfactant, or a combination of both. Any surfactant known in the art may be used in the present invention. In one embodiment, the surfactant is selected from the group of silicone surfactants. Generally, silicone surfactants may control cell size, closed cell content and shape of the rigid foam produced from the reaction of the resin composition and isocyanate composition.

In one embodiment, the surfactant may include non-ionic surfactants, cationic surfactants, anionic surfactants, amphoteric surfactants, and combinations thereof. In various embodiments, the surfactant may include, but is not limited to, polyoxyalkylene polyol surfactants, alkylphenol ethoxylate surfactants, and combinations thereof. In one embodiment, the salts of sulfonic acids, e.g., alkali metal and/or ammonium salts of oleic acid, stearic acid, dodecylbenzene-disulfonic acid or dinaphthylmethane-disulfonic acid, and ricinoleic acid, foam stabilizers such as siloxaneoxyalkylene copolymers and other organopolysiloxanes, oxyethylated alkyl-phenols, oxyethylated fatty alcohols, paraffin oils, castor oil, castor oil esters, and ricinoleic acid esters, and cell regulators, such as fatty alcohols, dimethylpolysiloxanes, and combinations thereof. In one embodiment, the foam composition may include Niax® L-6900.

If a surfactant is included in the resin composition, the surfactant may be present in any appropriate amount. In various embodiments, the surfactant is present in amounts of from 0.5 to 3, of from 1 to 3, or in about 2 weight percent of the foam composition. Here as elsewhere in the specification and claims, numerical values may be combined to form new or undisclosed ranges.

The foam composition may also include a non-silicone surfactant. The non-silicone surfactant may be used with the silicone surfactants or alone. Any surfactant known in the art may be used in the present invention. As such, the surfactant may include non-ionic surfactants, cationic surfactants, anionic surfactants, amphoteric surfactants, and combinations thereof. In various embodiments, the surfactant may include, but is not limited to, polyoxyalkylene polyol surfactants, alkylphenol ethoxylate surfactants, and combinations thereof. If the surfactant is included in the resin composition, the surfactant may be present in any appropriate amount.

The foam composition may also include one or more blowing agents including, but not limited to, physical blowing agents, chemical blowing agents, or any combination thereof. In one embodiment, the blowing agent may include both a physical blowing agent and a co-chemical blowing agent, and the blowing agent may be included in the foam composition. The physical blowing agent does not typically chemically react with the resin composition and/or an isocyanate to provide a blowing gas. The physical blowing agent may be a gas or liquid. A liquid physical blowing agent may evaporate into a gas when heated, and may return to a liquid when cooled. The physical blowing agent may reduce the thermal conductivity of the rigid polyurethane foam. The blowing agent may include, but is not limited methylene chloride, acetone, and liquid carbon dioxide, aliphatic and/or cycloaliphatic hydrocarbons such as halogenated hydrocarbons and alkanes, acetals, water, alcohols, glycerol, formic acid, and any combination thereof. In embodiments, the composition comprises a chemical blowing agent chosen from water, formic acid, or a combination thereof.

In various embodiments, the blowing agent may be selected from pentane isomers, hydrofluorocarbon, hydrofuloroolefins, volatile non-halogenated C2-C7 hydrocarbons such as alkanes, including N-pentane, alkenes, cycloalkanes having up to 6 carbon atoms, dialkyl ether, cycloalkylene ethers and ketones, and hydrofluorocarbons, C1-C4 hydrofluorocarbons, volatile non-halogenated hydrocarbon such as linear or branched alkanes such as butane, isobutane, 2,3-dimethylbutane, n- and isopentanes, n- and isohexanes, n- and isoheptanes, n- and isooctanes, n- and isononanes, n- and isodecanes, n- and isoundecanes, and n- and isodedecanes, alkenes such as 1-pentene, 2-methylbutene, 3-methylbutene, and 1-hexene, cycloalkanes such as cyclobutane, cyclopentane, and cyclohexane, linear and/or cyclic ethers such as dimethyl ether, diethyl ether, methyl ethyl ether, vinyl methyl ether, vinyl ethyl ether, divinyl ether, tetrahydrofuran and furan, ketones such as acetone, methyl ethyl ketone and cyclopentanone, isomers thereof, hydrofluorocarbons such as difluoromethane (HFC-32), 1,1,1,2-tetrafluoroethane (HFC-134a), 1,1,2,2-tetrafluoroethane (HFC-134), 1,1-difluoroethane (HFC-152a), 1,2-difluoroethane (HFC-142), trifluoromethane, heptafluoropropane (R-227a), hexafluoropropane (R-136), 1,1,1-trifluoro ethane, 1,1,2-trifluoroethane, fluoroethane (R-161), 1,1,1,2,2-pentafluoropropane, pentafluoropropylene (R-2125a), 1,1,1,3-tetrafluoropropane, tetrafluoropropylene (R-2134a), difluoropropylene (R-2152b), 1,1,2,3,3-pentafluoropropane, 1,1,1,3,3-pentafluoro-n-butane, and 1,1,1,3,3-pentafluoropentane (245fa), isomers thereof, 1,1,1,2-tetrafluoroethane (HFC-134a), isomers thereof, and combinations thereof. In various embodiments, the blowing agent may be further defined as 1,1,1,3,3-pentafluoropentane (245fa) or a combination of HFC 245fa, 365MFC, 227ea, and 134a. In an alternative embodiment, the blowing agent may be further defined as 365 MFC, which may be blended with 227ea.

In various embodiments, the blowing agent may be present in amounts of from 0.1 to 20, of from 1 to 18, of from 4 to 16, of from 7 to 14, of from 9 to 12, or of from 10 to 11 weight percent of the foam composition. Here as elsewhere in the specification and claims, numerical values may be combined to form new or undisclosed ranges. Generally, the amount of the blowing agent and/or water may be selected based on a desired density of the rigid foam and solubility of the blowing agent in the resin composition. It may be desirable to minimize amounts of the blowing agent used to reduce costs.

The foam composition may also include a cross-linker and/or a chain extender. The cross-linker may include, but is not limited to, an additional polyol, amines, and any combination thereof. If the cross-linker is included in the foam composition, the cross-linker may be present in any appropriate amount. Chain extenders contemplated for use in the present technology include, but not limited to, hydrazine, primary and secondary diamines, alcohols, amino acids, hydroxy acids, glycols, and combinations thereof. Specific chain extenders that are contemplated for use include, but are not limited to, mono and di-ethylene glycols, mono and di-propylene glycols, 1,4-butane diol, 1,3-butane diol, propylene glycol, dipropylene glycol, diethylene glycol, methyl propylene diol, mono, di- and tri-ethanolamines, N-N′-bis-(2 hydroxy-propylaniline), trimethylolpropane, glycerine, hydroquinone bis(2-hydroxyethyl)ether, 4,4′-methylene-bis(2-chloroaniline, diethyltoluenediamine, 3,5-dimethylthio-toluenediamine, hydrazine, isophorone diamine, adipic acid, silanes, and any combinations thereof.

The foam composition may also include one or more additives. Suitable additives include, but are not limited to, non-reactive fire retardants (e.g., various phosphates, various phosphonates, triethylphosphate, trichloropropylphosphate, triphenyl phosphate, or diethylethylphosphonate, tris(2-chloroethyl)phosphate, tris-ethyl-phosphate, tris(2-chloro-propyl)phosphate, tris(1,3-dichloropropyl)phosphate, diammonium phosphate, various halogenated aromatic compounds, antimony oxide, alumina trihydrate, polyvinyl chloride, and any combinations thereof), OH-free/non-reactive fire retardants, chain terminators, inert diluents, amines, anti-foaming agents, air releasing agents, wetting agents, surface modifiers, waxes, inert inorganic fillers, molecular sieves, reactive inorganic fillers, chopped glass, other types of glass such as glass mat, processing additives, surface-active agents, adhesion promoters, anti-oxidants, dyes, pigments, ultraviolet light stabilizers, thixotropic agents, anti-aging agents, anti-static additives,lubricants, coupling agents, solvents, rheology promoters, cell openers, release additives, and combinations thereof. The one or more additives may be present in the foam composition in any amount.

Polyurethane foam compositions employing the present compatibility additives can be provided as one-part ot two-part systems. In a one-part system, the respective components are provided as part of a single composition. Polyurethane foam compositions are of tent provided as two-part compositions. In a two-part composition, the polyol and the isocyanate are provided in separate compositions that are subsequently mixed together for forming the polyurethane. The isocyanate component in a two-part system is typically referred to in the art as the “A-side” component, and the polyol component is often referred to in the art as the “B-side” component.

In one embodiment, the polyurethane composition is provided as a two-part compostions, wherein the B-side component comprises a polyol and the compatibility additive. The B-side can include other components such as, but not limited to, catalysts, surfactants, flame retardants, blowing agents, and the like. In one-embodiment, the compatibility additive can be present in an amount of from about 0.5 wt. % to about 20 wt. %, from about 1 wt. % to about 15 wt. %, from about 2.5 wt. % to about 10 wt. %, or from about 5 wt. % to about 7.5 wt. % based based on the weight of the polyol composition. In one embodiment, the compatibility additive is present in an amount of from about 1.5 wt. % to about 7 wt. %, from about 2 wt. % to about 6 wt. %, or from about 2.5 wt. % to about 5 wt. %. based on the total weight of the polyol composition.

In one embodiment comprising a first compatibility additive where m is 0 and n is 1, and a second compatibility additive where m is ≥1 and n is ≥1, the first compatibility additive is present in an amount of from about 1 wt. % to about 15 wt. %, about 1.5 wt. % to about 12 wt. %, about 3 wt. % to about 10 wt. %, or about 4 wt. % to about 6%, and the second compatibility additive is present in an amount of from about 0.5 wt. % to about 6 wt. %, about 1 wt. % to about 5 wt. %, or about 2 wt. % to about 4 wt. %.

In addition to the foam composition, this technology also provides a method of forming the foam, and a method of forming the foam on a surface.

The method of forming the rigid foam typically includes the step of combining the polyol composition and the isocyanate composition. Most typically, the polyol and the isocyanate composition are combined such that the isocyanate index is about 250 or less. In embodiments, the isocyanate index is about 225 or less; about 200 or less; about 150 or less; about 125 or less; about 100 or less; even about 90 or less. In embodiments, the isocyanate index is from about 90 to about 250, from about 95 to about 240, from about 100 to about 200, from about 115 to about 180, even about 125 to about 165. In one embodiment, the isocyanate index is from about 90 to about 225; even from about 100 to about 200. Here as elsewhere in the specification and claims, numerical values may be combined to form new or undisclosed ranges. It will be appreciated by those skilled in the art that the foam may be a polyurethane foam or a polyisocyanurated foam. Foams in which the isocyanate index is about 250 are typically in the category of polyisocyanurate foams. It will be appreciated, however, that there is not an absolute value for the index to delineate a polyurethane foam from a polyisocyanurate foam.

The method of forming the rigid foam on the surface may include the steps of combining the components to form a foam mixture. Generally, the step of combining may occur in a mixing apparatus such as a static mixer, impingement mixing chamber, or a mixing pump. In one embodiment, the step of mixing occurs in a static mixing tube. Alternatively, the foam composition and the isocyanate composition may be combined in a spray nozzle.

In one embodiment, the components are combined with a stream of air typically having a pressure of from 1 to 5 psi. The isocyanate composition may be combined with the stream of air before being combined with the foam composition. Alternatively, the polyol and the modified novolac-type resin may be combined with the stream of air before being combined with the isocyanate composition. Further, the components may be combined simultaneously with the stream of air. The stream of air is thought to aid in mixing and promote even spraying and distribution of the foam mixture.

The components may be combined while on a surface or apart from the surface. In one embodiment, the components may be combined in the head of a spray gun or in the air above the surface to which the composition is being applied. The components may be combined and applied to the surface by any method known in the art including spraying, dipping, pouring, coating, painting, etc.

The present technology provides a rigid polyurethane foam (“rigid foam”). The rigid foam may be open or closed celled and may include a highly cross-linked, polymer structure that allows the foam to have good heat stability, high compression strength at low density, low thermal conductivity, and good barrier properties. Typically, the rigid foam of this technology may have glass transition temperature greater than room temperature (approximately 23° C.+/−2° C. (approximately 73.4° F.+/−3.6° F.)) and is typically rigid at room temperature. Generally, foams are rigid at or below their glass transition temperatures especially in glassy regions of their storage moduli. The rigid foam may have density of from about 10 to about 1,100 kg/m³, from about 50 to about 1,000 kg/m³, from about 100 to about 850 kg/m³, from about 250 to about 650 kg/m³, even from about 350 to about 500 kg/m³. In one embodiment, the rigid foam may have density of from about 10 to about 50 kg/m³, Here as elsewhere in the specification and claims, numerical values may be combined to form new or undisclosed ranges.

The foam mixture may be applied to any appropriate surface, e.g., brick, concrete, masonry, dry-wall, sheetrock, plaster, metal, stone, wood, plastic, a polymer composite, or any combination thereof. Additionally, the surface may be a surface of a mold and, therefore, the rigid foam may be formed in the mold.

The resulting rigid foam may be used in the form of a slabstock, a molding, or a filled cavity. The filled cavity, e.g., may be a pipe, insulated wall, insulated hull structure. The rigid foam may be a sprayed foam, a frothed foam, or a continuously-manufactured laminate product or discontinuously-manufactured laminate product, including but not limited to a laminate or laminated product formed with other materials, such as hardboard, plasterboard, plastics, paper, metal, or a combination thereof.

The foam mixture may be sprayed at a spray rate of from 1 to 30 lbs/min, at a rate of from 5 to 25 lbs/min, and even at a rate of from 5 to 20 lbs/min. Also, the foam mixture may generally be sprayed at a pressure of less than 3000 psi. Here as elsewhere in the specification and claims, numerical values may be combined to form new or undisclosed ranges.

In various embodiments, the foam mixture may be sprayed in a single pass such that the rigid foam being formed therefrom has a (single pass) thickness of from 1 to 10 inches, from 2 to 8 inches, from 3 to 7 inches, from 4 to 6 inches, from 4 to 5 inches, or even from 6 to 9 inches, with minimal or no visible discoloration and/or scorch. Here as elsewhere in the specification and claims, numerical values may be combined to form new and non-disclosed ranges.

Rigid foams comprising the foam compositions described above may be further understood with reference to the following examples.

### Examples

Polyol compositions were prepared according to the following formulations:

TABLE 1

| | Exam- | Exam- | Exam- | Exam- | Exam- |
|---|---|---|---|---|---|
| | ple 1 | ple 2 | ple 3 | ple 4 | ple 5 |
| Material | pphp | pphp | pphp | pphp | pphp |
| Voranol 490 | 60 | 60 | 60 | 60 | 60 |
| Voranol 800 | 40 | 40 | 40 | 40 | 40 |
| Water | 3 | 3 | 3 | 3 | 3 |
| C-5 | 0.5 | 0.5 | 0.5 | 0.5 | 0.5 |
| C-41 | 0.3 | 0.3 | 0.3 | 0.3 | 0.3 |
| Opteon | 35.09 | 35.09 | | | |
| 1100/1150 | | | | | |
| (7/3) | | | | | |
| Solstice LBA | | | 28.05 | 28.05 | |
| Cyclopentane | | | | | 15 |
| Surfactant | 4.3 | 5.78 | 4.08 | 5.5 | 3.7 |
| Total | 143.19 | 144.67 | 135.39 | 137.35 | 122.5 |

Tests were run with compositions using different surfactants. The surfactants are silicone surfactants of the MDxD'yM type where the D′ unit contains pendant polyether functional groups. The polyether functional groups can include ethylene oxide and/or propylene oxide units in the polyether chain. The surfactants employed in each of the compositions are listed in Table 2:

TABLE 2

| Additive | | | | MW PE | MW | MW |
|---|---|---|---|---|---|---|
| label reference | x:y | EO | PO | single | Silicone | copolymer |
| Surfactant 1 | 6.4 | 12 | 3 | 743 | 3774 | 8827 |
| Surfactant 2 | 4.7 | 12 | 0 | 569 | 3818 | 8939 |
| Surfactant 3 | 13.6 | 12 | 3 | 743 | 1868 | 3056 |
| Surfactant 4 | 6.3 | 18 | 4 | 1065 | 3530 | 10346 |
| Surfactant 5 | 6.4 | 12 | 0 | 569 | 3774 | 7644 |
| Surfacatant 6 | 8.7 | 12 | 2 | 685 | 5433 | 10571 |
| Surfactant 7 | 4.7 | 18 | 4 | 1065 | 3818 | 13403 |

A compatibilizer was added to the composition. The compatibility additives evaluated were materials in accordance with Formula (I). The compatibility additives were trisiloxanes (in which m is 0 in Formula (I)) and polysiloxane polyalkyleneoxide copolymer additives (where m is greater than 0 in Formula (I)). The composition of the compatibility additives are listed in Table 3:

TABLE 3

| Compatibility | | | | | | PE | MW | MW | MW | % |
|---|---|---|---|---|---|---|---|---|---|---|
| Additive | m | n | p | q | R11 | terminus | PE | Silicone | copolymer | Si |
| Additive A | 0 | 1 | 3 | 0 | H | H | 215 | 222 | 437 | 19.2 |
| Additive B | 0 | 1 | 0 | 4 | H | H | 217 | 222 | 439 | 19.1 |
| Additive C | 0 | 1 | 3 | 5 | H | H | 435 | 222 | 657 | 12.8 |
| Additive D | 0 | 1 | 0 | 7 | H | H | 349 | 222 | 571 | 14.7 |
| Additive E | 0 | 1 | 0 | 7 | H | Me | 363 | 222 | 585 | 14.3 |
| Additive F | 0 | 1 | 3 | 12 | Me | H | 757 | 222 | 979 | 8.6 |
| Additive G | 1.8 | 0.95 | 0 | 4 | H | H | 217 | 353 | 559 | 23.9 |
| Additive I | 18 | 0.95 | 3 | 12 | Me | H | 757 | 353 | 1059 | 12.6 |
| Additive K | 0.9 | 2.4 | 3 | 12 | H | H | 215 | 373 | 889 | 8.7 |
| Additive P | 0 | 1 | 3 | 12 | H | H | 743 | 222 | 965 | 19.2 |

The following tables identify the initial appearance of the polyol pre-blend with the respective surfactants, and the amount of compatibility additive added to obtain a clear, homogenous solution. Comparative examples (designated as “CE”) were also run with out any surfactant. In some examples, materials falling under the composition of formula (I) in accordance with the present invention were evaluated as surfactants alone.

TABLE 4
Polyol Solution: Example 1

| | | Polyol | Wt. % |
|---|---|---|---|
| | | Solution - | Additive |
| | | Example 1 | A required |
| | | 3 wt. % surf | for clear |
| | | initial | homogeneous |
| Example | Surfactant | appearance | solution |
| 1-1 | 1 | Hazy | 6.0 |
| 1-2 | 2 | Clear w/sep* | 3.0 |
| 1-3 | 3 | Hazy w/sep | >12.0 |
| 1-4 | 4 | Hazy w/sep | 6.0 |
| 1-5 | Additive | Clear w/sep | 3.0 |
| | A | | |
| 1-6 | 5 | Hazy w/sep | 3.0 |
| 1-7 | Additive | Clear w/sep | 3.0 |
| | B | | |
| 1-8 | 6 | Hazy | 9.0 |
| CE -1 | No Surf | Clear w/sep | — |
| 1-9 | 7 | Hazy w/sep | 3.0 |
| 1-10 | Additive | Clear | Not needed |
| | F | | |

Table 4 shows the evaluation of compatibility additives with the poloyol of Example 1 employing the various surfactants. The blowing agent employed with the polyol of Example 1 is hydrofluoroolefin (HFO-1366mzz-Z). Without the compatibility additive, the polyol compositions are either hazy or clear but with separation of the components. Adding the compatibility additive in at least a 1:1 ratio or greater provided for clear, homogenous solutions except for the comparative example CE-1. For surfactants 2, 5, and 7, an equivalent amount of compatibility additive was suitable for obtain a clear, homogenous solution. An equivalent amount of compatibility additive is also suitable where the compatibility additives were used as the surfactant.

TABLE 5

| | | Polyol | Wt. % |
|---|---|---|---|
| | | Solution - | Additive |
| | | Example 2 | A required |
| | | 4 wt. % surf | for clear |
| | | initial | homogeneous |
| Example | Surfactant | appearance | solution |
| 2-1 | 1 | Hazy w/sep | 8.0 |
| 2-2 | 2 | Clear w/sep | 4.0 |
| 2-3 | 3 | Hazy w/sep | >12.0 |
| 2-4 | 4 | Hazy w/sep | 8.0 |
| 2-5 | Additive | Clear w/sep | 4.0 |
| | A | | |
| 2-6 | 5 | Hazy w/sep | 4.0 |
| 2-7 | Additive | Clear w/sep | 4.0 |
| | B | | |
| 2-8 | 6 | Hazy w/sep | 8.0 |
| CE-2 | No Surf | Clear w/sep | — |
| 2-0 | 7 | Hazy w/sep | 4.0 |

Table 5 shows the evaluation of compatibility additives with the poloyol of Example 2 employing the various surfactants. The blowing agent employed with the polyol of Example 2 is hydrofluoroolefin (HFO-1366mzz-Z). Surfactants having a high m:n ratio (greater than 6:1) required use of the compatibility additive at an amount at least twice the amount of the surfactant. Surfactants with lower m:n ratios required less compatibility additive.

TABLE 6

| | | Polyol | Wt. % |
|---|---|---|---|
| | | Solution - | Additive |
| | | Example 3 | A required |
| | | 3 wt. % surf | for clear |
| | | initial | homogeneous |
| Example | Surfactant | appearance | solution |
| 3-1 | 1 | Hazy w/sep | 6.0 |
| 3-2 | 2 | Clear | not needed |
| 3-3 | 3 | Hazy w/sep | 24.0 |
| 3-4 | 4 | Hazy w/sep | 6.0 |
| 3-5 | Additive | Clear | not needed |
| | A | | |
| 3-6 | 5 | Hazy w/sep | 6.0 |
| 3-7 | Additive | Clear | not needed |
| | B | | |
| 3-8 | 6 | Hazy w/sep | 12.0 |
| CE-3 | No Surf | Clear | — |
| 3-9 | 7 | Hazy w/sep | 3.0 |
| 3-10 | Additive | Clear | Not needed |
| | F | | |

Table 6 shows the evaluation of compatibility additives with the poloyol of Example 3 employing the various surfactants. The blowing agent employed with the polyol of Example 3 is hydrofluoroolefin (HFO-1233zd(E). With this blowing agent, the polyol solution was initially clear with Surfactat 2, no surfactant, and when Additive A and B were added as the surfactant. These solutions did not require any compatibility additive. Surfactant 7,which has an m:n ratio of less than 6 only required an equivalent amount of compatibility additive relative to the surfactant. The other surfacants with the higher m:n ratio required at least two time the amount of compatibility additive.

TABLE 7

| | | Polyol | Wt. % |
|---|---|---|---|
| | | Solution - | Additive |
| | | Example 4 | A required |
| | | 4 wt. % surf | for clear |
| | | initial | homogeneous |
| Example | Surfactant | appearance | solution |
| 4-1 | 1 | Hazy w/sep | 8.0 |
| 4-2 | 2 | Clear | not needed |
| 4-3 | 3 | Hazy | 24.0 |
| 4-4 | 4 | Hazy w/sep | 8.0 |
| 4-5 | Additive | Clear | not needed |
| | A | | |
| 4-6 | 5 | Hazy | 4.0 |
| 4-7 | Additive | Clear | not needed |
| | B | | |
| 4-8 | 6 | Hazy w/sep | 16.0 |
| CE-4 | No Surf | Clear | — |
| 4-9 | 7 | Hazy w/sep | 4.0 |

The polyol solution of Example 4 is similar to Example 3 except that Example 4 uses a larger amount of surfactant. As with Example 3, the polyol solution was clear with the use of surfactant 2 and Additives A and B as surfactant. Surfactant 1 and 4 required 2× the use level of compatibilizer compared to main surfactant and Surfactants 3 and 6 required further additions to bring clarity to the polyol pre-blend. Structural analysis shows that those with low m:n (less than 6) require less loading of the compatibilizer and may be of utility as compatibilizer themselves, albeit less efficiently than the noted Additives A-F.

TABLE 8

| | | Polyol | Wt. % |
|---|---|---|---|
| | | Solution - | Additive |
| | | Example 5 | A required |
| | | 3 wt. % surf | for clear |
| | | initial | homogeneous |
| Example | Surfactant | appearance | solution |
| 5-1 | 1 | Hazy w/sep | 18.0 |
| 5-2 | 2 | Hazy w/sep | 9.0 |
| 5-3 | 3 | Hazy w/sep | 30.0 |
| 5-4 | 4 | Hazy w/sep | 15.0 |
| 5-5 | Additive | Hazy w/sep | 12.0 |
| | A | | |
| 5-6 | 5 | Hazy w/sep | 15.0 |
| 5-7 | Additive | Hazy w/sep | 9.0 |
| | B | | |
| 5-8 | 6 | Hazy w/sep | 21.0 |
| CE-5 | No Surf | Hazy w/sep | — |
| 5-9 | 7 | Hazy w/sep | 12.0 |

Without being bound to any particular theory, Table 8 may indicate that polarity of the surfactant, polyol pre-blend, blowing agent and compatibility additive are relevant to maintaining the homogeneity of the system.

### Foam Preparations

Foams were prepared using the polyol pre-blend of Example 1 with either surfactant 1 or surfactant 6. The foams were prepared as follows. All B-side (polyol) components are added to a bottle and capped closed. The bottle is rolled 30 minutes to provide adequate mix. The bottle of the B-side composition is temperature controlled to 70° F. This can be accomplished using a water bath or the room itself. If in a water bath, the bottle is shaken well before weighing out the components to keep them mixed. The blend is very low viscosity and mixes easily.

The B-side blend is weighed out on a balance in a paper cup to the required amount to fill a 12″x12″x3″ mold. This amount is typically around 240 g to fill the mold with 10% overpack. The isocyanate (Papi 27 or similar) is then added to the cup on top of the polyol mixture. The mixture is then mixed for 4 seconds at 3500 RPM and poured into the mold for 5 seconds. The mold is closed for a 4 minute demold period at 120° F. The foam pad is removed and stored in the testing lab overnight (16 hours) at room conditions of 70° F. and cut the next day.

Physical Properties analysis procedure: The physical properties of the foam are analyzed as follows.

K-factor: An 8″x8″x1″ sample is cut from the core of the foam for analyzing thermal conductivity. It is run on a Fox200 instrument by Lasercomp at 100° F. lower plate and 50° F. upper plate to a mean of 75° F. following ASTM C-1289.

The pad density and K-factor of the foams was evaluated in foams made with polyol pre-blends containing only surfactant 1 or 6 and those where Additive A is added to the polyol pre-blend.

Table 9 shows the foam properties for these foams.

TABLE 9

| | | Total Pad | K-factor | Core |
|---|---|---|---|---|
| | | density | (BTU · In/Hr. · | Density |
| Foam | | (pcf) | ft² · ° F.) | (pcf) |
| CF-1 | No emulsifier w/ | 2.12 | 0.1464 | 1.87 |
| | Surfactant 1 | | | |
| Foam 1 | adding 3 wt. % Additive | 2.14 | 0.1464 | 1.9 |
| | A | | | |
| | % change | 0.94 | 0.0000 | 1.60 |
| | Adding 6 wt % Additive | 2.11 | 0.1541 | 1.94 |
| | A | | | |
| | % change | 0.47 | 5.2596 | 3.74 |
| CF-2 | No emulsifier w/ | 2.12 | 0.1469 | 1.86 |
| | Surfactant 6 | | | |
| Foam 2 | addin 3 wt. % | 2.15 | 0.146 | 1.94 |
| | Additive A | | | |
| | % change | 1.42 | 0.6127 | 4.30 |
| Foam 3 | Adding 9% Additive A | 2.13 | 0.1472 | 1.95 |
| | % change | 0.47 | 0.2042 | 4.84 |

Table 9 shows minimal change in density (attributed to pour time and viscosity reduction when hand-mixing) and k-factor using the polyol of Example 1. This indicates at low to moderate use level (less than 12%) the impact on the physical properties of rigid foams using various blowing agents is minimally impacted by the use of the invention and the materials remain clear for an extended period of time.

Foams were made with the polyol pre-blend of Example 3 and surfactant 1 and surfactant 6. Foams were made with no compatibility additive and also with the addition of 7.5 and 9.0 wt. % of Additive A. 9.0% Additive A was near the maximum use level required to obtain homogeneity of the polyol pre-blend (Example 3) noted in Table 4 and greater than that need to compatibilize Example 5 (Table 8) using Surfactant 2. Foams were made using Surfactant 2 as the main surfactant with the addition of Additive A at 7.5 and 9.0 wt. % in both formulations B and F (3% surf) to determine the impact on physical properties of the higher use level of the invention when using a more optimal main surfactant (Table 10).

TABLE 10

| | | | Total Pad | K-factor | Core |
|---|---|---|---|---|---|
| | | | density | (BTU · In/Hr. · | Density |
| Foam | Polyol | | (pcf) | ft² · ° F.) | (pcf) |
| CF-3 | Exam- | No | 2.15 | 0.1427 | 1.89 |
| | ple 1 | compatibilizer | | | |
| | | w/Surfactant 1 | | | |
| Foam 4 | Exam- | 7.5% Additive | 2.28 | 0.144 | 1.98 |
| | ple 1 | A | | | |
| | | % change | 6.05 | 0.91 | 4.76 |
| CF-4 | Exam- | No | 2.15 | 0.1433 | 1.9 |
| | ple 5 | compatibilizer | | | |
| | | w/Surfactant 6 | | | |
| Foam 5 | Exam- | 9.0% Additive | 2.28 | 0.1445 | 1.99 |
| | ple 5 | A | | | |
| | | % change | 6.05 | 0.84 | 4.74 |

Additional studies were done with other compatibility additives. Tables 11-13 show the use of Additives A, B, C, D, E, F, G, 1, K, and P to achieve clear, homogenous solutions for polyol pre-blends of Examples 1, 3, and 5.

TABLE 11

| Polyol of Example 1 | Surfactant 1 | Surfactant 6 |
|---|---|---|
| Initial Appearance at 3 wt. % | Hazy | Hazy |
| surfactant | | |
| Appearance with up to 9 wt. % | Hazy | Hazy |
| additional surfactant 1 | | |
| Wt. % Addition of Surfactant | 7.5 | 9.0 |
| 2 - Amount required for clear | | |
| homogenous solution | | |
| Wt. % Addition of Additive A | 6.0 | 9.0 |
| required for clear | | |
| homogenous solution | | |
| Wt. % Addition of Additive B | 6.0 | 9.0 |
| required for clear | | |
| homogenous solution | | |
| Wt. % Addition of Additive C | 6.0 | 9.0 |
| required for clear | | |
| homogenous solution | | |
| Wt. % Addition of Additive D | 6.0 | 7.5 |
| required for clear | | |
| homogenous solution | | |
| Wt. % Addition of Additive E | N/A - Hazy | N/A - Hazy |
| required for clear | up to 9.0% | up to 9.0% |
| homogenous solution | | |
| Wt. % Addition of Additive F | 7.5 | 7.5 |
| required for clear | | |
| homogenous solution | | |
| Wt. % Addition of Additive G | 7.5 | N/A - Hazy |
| required for clear | | up to 10.5% |
| homogenous solution | | |
| Wt. % Addition of Additive I | 7.5 | N/A - Hazy |
| required for clear | | up to 10.5% |
| homogenous solution | | |
| Wt. % Addition of Additive K | 9.0 | N/A - Hazy |
| required for clear | | up to 10.5% |
| homogenous solution | | |
| Wt. % Addition of Additive P | 7.5 | 9.0 |
| required for clear | | |
| homogenous solution | | |

TABLE 12

| Polyol of Example 3 | Surfactant 1 | Surfactant 6 |
|---|---|---|
| Initial Appearance at 3 wt. % | Hazy | Hazy |
| surfactant | | |
| Appearance with up to 9 wt. % | Hazy | Hazy |
| additional surfactant 1 | | |
| Wt. % Addition of Surfactant | 6.0 | 7.5 |
| 2 - Amount required for clear | | |
| homogenous solution | | |
| Wt. % Addition of Additive A | 6.0 | 12.0 |
| required for clear | | |
| homogenous solution | | |
| Wt. % Addition of Additive B | 7.5 | 7.5 |
| required for clear | | |
| homogenous solution | | |
| Wt. % Addition of Additive C | 7.5 | 9.0 |
| required for clear | | |
| homogenous solution | | |
| Wt. % Addition of Additive D | 6.0 | 7.5 |
| required for clear | | |
| homogenous solution | | |
| Wt. % Addition of Additive E | N/A - Hazy | N/A - Hazy |
| required for clear | up to 9.0% | up to 9.0% |
| homogenous solution | | |
| Wt. % Addition of Additive F | 7.5 | 7.5 |
| required for clear | | |
| homogenous solution | | |
| Wt. % Addition of Additive G | 10.5 | N/A - Hazy |
| required for clear | | up to 9% |
| homogenous solution | | |
| Wt. % Addition of Additive I | 10.5 | N/A - Hazy |
| required for clear | | up to 9% |
| homogenous solution | | |
| Wt. % Addition of Additive K | N/A - Hazy | N/A - Hazy |
| required for clear | up to 10.5% | up to 9% |
| homogenous solution | | |
| Wt. % Addition of Additive P | 9.0 | 9.0 |
| required for clear | | |
| homogenous solution | | |

TABLE 13

| Polyol of Example 5 | Surfactant 1 | Surfactant 6 |
|---|---|---|
| Initial Appearance at 3 wt. % | Hazy | Hazy |
| surfactant | | |
| Appearance with up to 15 | Hazy | Hazy |
| wt. % additional surfactant 1 | | |
| Wt. % Addition of Surfactant | 12.0 | 12.0 |
| 2 - Amount required for clear | | |
| homogenous solution | | |
| Wt. % Addition of Additive A | 18.0 | 21.0 |
| required for clear | | |
| homogenous solution | | |
| Wt. % Addition of Additive B | 15.0 | 15.0 |
| required for clear | | |
| homogenous solution | | |
| Wt. % Addition of Additive C | 15.0 | 15.0 |
| required for clear | | |
| homogenous solution | | |
| Wt. % Addition of Additive D | 12.0 | 12.0 |
| required for clear | | |
| homogenous solution | | |
| Wt. % Addition of Additive E | N/A - Hazy | N/A - Hazy |
| required for clear | up to 15.0% | up to 15.0% |
| homogenous solution | | |
| Wt. % Addition of Additive F | 12.0 | 12.0 |
| required for clear | | |
| homogenous solution | | |

Embodiments of the technology have been described above and modifications and alterations may occur to others upon the reading and understanding of this specification. The claims as follows are intended to include all modifications and alterations insofar as they come within the scope of the claims or the equivalent thereof.

1. A polyurethane or polyisocyanurate foam composition comprising:
a polyol or a mixture thereof;
an isocyanate;
a compatibility additive;
a surfactant; and
a polyurethane catalyst or a mixture thereof;
wherein the compatibility additive is selected from a compound of the formula: 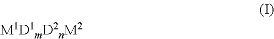
where:
M¹ is (R¹)(R²)(R³)Si—O_{1/2}
M² is (R⁴)(R⁵)(R⁶)Si—O_{1/2}
D¹ is (R⁷)(R⁸)Si—O_{2/2}
D² is (R⁹)(R¹⁰)Si—O_{2/2}
R¹⁰ is —CH₂—CH(R¹⁰)—CH₂—O—[CH₂CH(CH₃)O]ₚ—[CH₂CH₂O]_{q}—R¹²
R¹, R², R³, R⁴, R⁵, and R⁶, are independently selected from a C1-C10 alkyl or R¹⁰;
R⁷, R⁸, and R⁹ are independently selected from a C1-C10 alkyl,
R¹¹ is H or a C1-C10 alkyl;
R¹² is H, a C1-C10 alkyl, or an acetyl group;
m is 0 to 100;
n is 1 to 50;
p is 0 to 35;
q is 0-45; and
p+q≥1.

2. The composition of claim 1, wherein the composition is a two-part composition comprising (i) a first part comprising the isocyanate, and (ii) a second part comprising the polyol and the compatibility additive.

3. The composition of claim 1, wherein m is 0 and n is 1.

4. The composition of claim 3, wherein p is 1 to 10.

5. The composition of claim 4, wherein q is 0.

6. The composition of claim 3, wherein q is 1 to 10.

7. The composition of claim 6, wherein p is 0.

8. The composition of claim 1, wherein m≥0, and n is ≥1, wherein m:n is ≤6:1.

9. The composition of claim 8, wherein the ratio of m:n is from about 0.1:1 to 6:1

10. The composition of claim 8, wherein 0<m≤15 and 1<n≤5.

11. The composition of claim 1, wherein R¹¹ is H.

12. The composition of claim 1, wherein R¹¹ is a C1-C10 alkyl.

13. The composition of claim 12, wherein R¹¹ is methyl.

14. The composition of claim 1 wherein the compound of Formula (I) has a silicon content of less than 25 wt. % of the weight of Formula (I).

15. The composition of claim 1, wherein the compound of Formula (I) has a silicon content of less than 20 wt. % of the weight of Formula (I).

16. The composition of claim 1, wherein the compound of Formula (I) has a silicon content of from about 1 wt. % to about 25 wt. % of the weight of Formula (I).

17. The composition of claim 1, wherein the compatibility additive is present in an amount of from about 0.5 to about 20 parts per one hundred parts polyol.

18. The composition of claim 1, wherein the compatibility additive is present in an amount equivalent to the amount of surfactant present in the composition.

19. The composition of claim 1, wherein the compatibility additive is present in an amount of greater than the amount of surfactant present in the composition.

20. The composition of claim 19, wherein the compatibility additive is present in an amount of from about 1.2 times to 6 times the amount of surfactant present in the composition.

21. The composition of claim 1 further comprising a blowing agent.

22. A method of forming a foam comprising reacting the composition of claim 1.
